(19) United States
(12) Patent Application Publication
(10) Pub. No.: US 2017/0347143 A1
(43) Pub. Date: Nov. 30, 2017

(54) PROVIDING SUPPLEMENTAL CONTENT WITH ACTIVE MEDIA

(71) Applicant: Amazon Technologies, Inc., Reno, NV (US)

(72) Inventors: David A. Limp, Medina, WA (US); Charles G. Tritschler, Los Altos, CA (US); Peter A. Larsen, Seattle, WA (US)

(21) Appl. No.: 15/675,573

(22) Filed: Aug. 11, 2017

Related U.S. Application Data
(63) Continuation of application No. 13/529,818, filed on Jun. 21, 2012, now abandoned.

(51) Int. Cl. H04N 21/41; H04N 21/488; H04N 21/482; H04N 21/478; H04N 21/45; H04N 21/4415; H04N 21/44; H04N 21/439; H04N 21/435; H04N 21/81; H04N 21/422

(52) U.S. Cl. CPC H04N 21/4126; H04N 21/8133; H04N 21/4882; H04N 21/4828; H04N 21/4826; H04N 21/47815; H04N 21/42203; H04N 21/4415; H04N 21/44008; H04N 21/4394; H04N 21/435; H04N 21/42209; H04N 21/4532

(57) ABSTRACT

A user viewing a presentation of media content can obtain related supplemental content through the same or a different interface, on the same or a different device. A listener or other such component can attempt to detect information about the media, such as tags present in the media, the occurrence of songs or people in the media, and other such information. The detected information can be analyzed to attempt to identify one or more aspects of the media. The identified aspects can be used to attempt to locate supplemental content that is related to the media content and potentially of interest to the user. The interest of the user can be based upon historical user data, preferences, or other such information. The user can be notified of supplemental content on a primary display, and can access the supplemental content on a secondary display, on the same or a separate device.

### CROSS-REFERENCE TO RELATED APPLICATIONS

This application is a continuation of U.S. patent application Ser. No. 13/529,818, filed Jun. 21, 2012, the content of which is incorporated herein by reference.

### BACKGROUND

Users are increasingly relying upon electronic devices to obtain various types of information. For example, a user viewing a television show might want to determine the identity of a particular actor in the show, and may utilize a Web browser on a separate computing device to search for the information. Similarly, a user watching a movie might hear a song that is of interest to the user, and might want to determine the name of the song and where the user can obtain a copy. Oftentimes, this involves the user either hoping to remember to lookup the information after the movie or show is over, or stopping the presentation to search for the information. In some cases there might be information available that the user might not know exists, such as related shows or books upon which a movie is based, but that the user might otherwise be interested in. As the amount of such information available is increasing, there is room for improvement in the way in which this information is organized, available, and presented to various users.

### BRIEF DESCRIPTION OF THE DRAWINGS

Various embodiments in accordance with the present disclosure will be described with reference to the drawings, in which:

FIG. 1 illustrates an example presentation of supplemental content that can be utilized in accordance with various embodiments;

FIG. 2 illustrates an example environment in which aspects of the various embodiments can be that can be implemented;

FIG. 3 illustrates an example presentation of supplemental content that can be utilized in accordance with various embodiments;

FIG. 4 illustrates an example presentation of supplemental content that can be utilized in accordance with various embodiments;

FIG. 5 illustrates an example presentation of supplemental content that can be utilized in accordance with various embodiments;

FIG. 6 illustrates an example process for determining and selecting supplemental content to display to a user that can be utilized in accordance with various embodiments;

FIG. 7 illustrates an example presentation of supplemental content that can be utilized in accordance with various embodiments;

FIG. 8 illustrates an example device that can be used to implement aspects of the various embodiments;

FIG. 9 illustrates example components of a client device such as that illustrated in FIG. 8; and

FIG. 10 illustrates an environment in which various embodiments can be implemented.

### DETAILED DESCRIPTION

Systems and methods in accordance with various embodiments of the present disclosure overcome one or more of the above-referenced and other deficiencies in conventional approaches to providing content to a user of an electronic device. In particular, various embodiments enable supplemental content to be selected and provided to a user by analyzing or otherwise monitoring a presentation of media content through an interface of a computing device. A listener or other such component or service can be configured to monitor media content for information that is indicative of an aspect of the media content, such as a tag, metadata, or object contained in a video and/or audio portion of the content. In response to detecting such information, a system or service can attempt to locate related or “supplemental” content, such as may include additional information about the media content, related instances of content that a user can access, items that might be of interest to viewers of the content, and the like. Located supplemental content can be displayed (or otherwise presented) in a separate interface region, either on the same device or on a separate device. Information can pass back and forth between the interface regions, enabling the user to access supplemental content that is relevant to a current location in the media, and enable control of one or more aspects of the displayed media through interaction with the supplemental content. In some embodiments, a user can view media content on a first device and obtain supplemental content on a second device. In such embodiments, the first device might display notifications about the supplemental content, which the user can then access on the second device. In other embodiments, the media and/or supplemental displays can have an adjustable size and/or transparency value such that a user can continue viewing the media content while also accessing the supplemental content on the same device. In at least some embodiments, the media and supplemental content are displayed in linked windows that the user can switch between, such as by shifting one of the windows into a smaller, translucent view when accessing content in the other window.

Various other functions and advantages are described and suggested below as may be provided in accordance with the various embodiments.

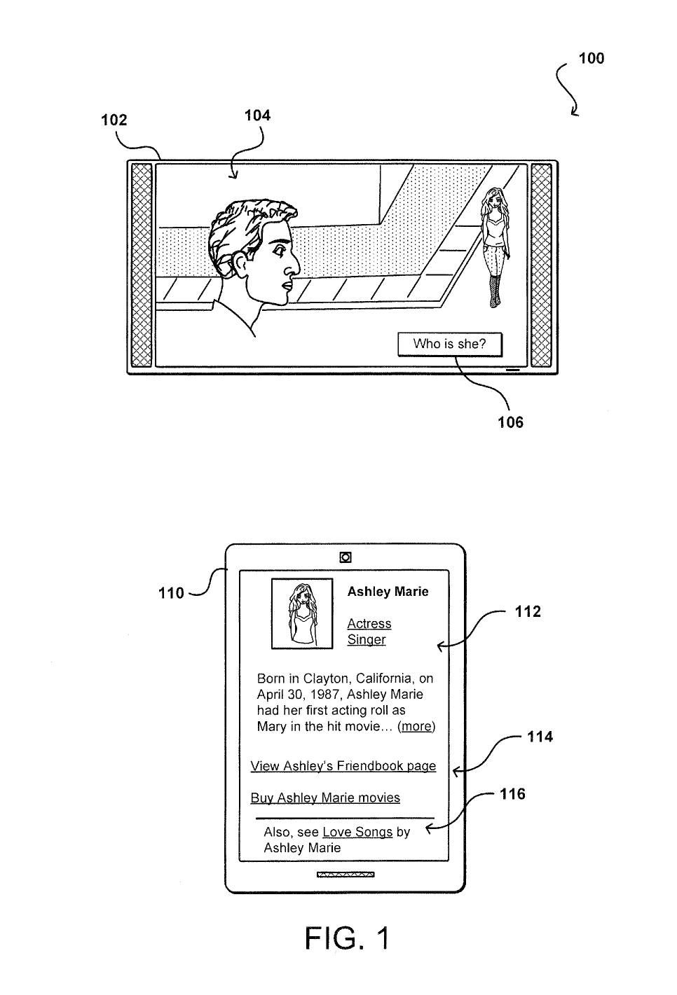

FIG. 1 illustrates an example environment 100 in which aspects of the various embodiments can be implemented. In this example, a user is able to view content on two different types of device, in this example a television 102 and a tablet computer 110. It should be understood, however, that the user can utilize one or more devices of the same or different types within the scope of the various embodiments, and that the devices can include any appropriate devices capable of receiving and presenting content to a user, as may include electronic book readers, a smart phones, desktop computers, notebook computers, personal data assistants, video gaming consoles, television set top boxes, and portable media players, among other such devices. In this example, a user has selected a movie to be displayed through the television 102. The user can have selected the movie content using any appropriate technique, such as by using a remote control of the television to select a channel or order the movie, using the tablet computer 110 to select a movie to be streamed to the television, or another such mechanism. The movie content 104 can be obtained in any appropriate way, such as by streaming the content from a remote media server, accessing the content from a local server or storage, or receiving a live feed over a broadcast or cable channel, among others. In at least some embodiments, the type and/or quality of the media presentation can depend upon factors such as capabilities of the device being used to present the media, a type or level of subscription, a mechanism by which the media data is being delivered, and other such information.

As mentioned above, there can be various types of information available that relate to aspects of the media presentation. For example, there can be information about the media content itself, such as name of actors in a movie, lines of dialog, trivia about the movie, and other such information. There also can be various versions of that media available for purchase, such as through physical media or download. There can be songs played during the presentation of the media that can be identified, with information about those songs being available as well as options to obtain those songs. Similarly, there might be books, graphic novels, or other types of media related to the movie. There can be items that are displayed in the movie, such as clothing worn by a character or furniture in a scene, as well as toys or merchandise featuring images of the movie or other such information. Various other types of information can be related to the media content as well as discussed and suggested elsewhere herein.

Traditionally, a user wanting to obtain any of this additional information would have to access a computing device, such as the tablet computer 110, and perform a manual search to locate information relating to the movie or other such media presentation. Oftentimes a user will navigate to one of the first search results, which might include information about the cast or other specific types of information. In many cases it may be difficult to search for particular items or information. For example, it might be difficult for a user to determine the type of outfit a character is wearing without a significant amount of effort, which might take away from the user's enjoyment of the movie while the user is searching. Similarly, the user might not know that a movie is based on a book, for example, such that the user would not even be aware to search for such information.

Approaches in accordance with various embodiments can notify the user of the availability of such information, and can enable the user to quickly access that information on the same device or a separate device. In at least some embodiments, a determination can be made of the likely relevance of a certain item or piece of information to a user, or a level of interest of the user in that item or information, in order to limit the presentation of this additional information, or “supplemental content,” to only information that is determined to be highly relevant to a particular user. Further, there are various ways to notify the user of the availability of supplemental content, and enable a user to access the supplemental content, in order to maintain a positive user experience while providing information that is likely of interest to the user.

In FIG. 1 a determination is made that there is information available about an actor that has appeared on the screen. In this example, a small notification element 106 is temporarily displayed on the television. The notification can take any appropriate size and shape, and can be displayed by fading in and out after a period of time, moving on and then off the screen, etc. Further, the notification can be an active or passive notification in different embodiments. For example, in FIG. 1 the notification is a passive notification that appears for a period of time on the screen to notify the user of the availability of information, and then disappears from the screen. In this example, the notification indicates to the user that information about the actress is available on a related device of the user. In this example, the information has been pushed to the tablet device 110 associated with the user, although the content could have been pushed to another device or to the television itself as discussed later herein. The user thus can be notified of the presence of the information 112 on the tablet computer 110. Other information can be displayed as well, such as links 114 to related pages or items, or options 116 to view or purchase other types of items related to a subject of the information. Various other types of information can be presented as well, as least some of which can be selected based upon information known about the user.

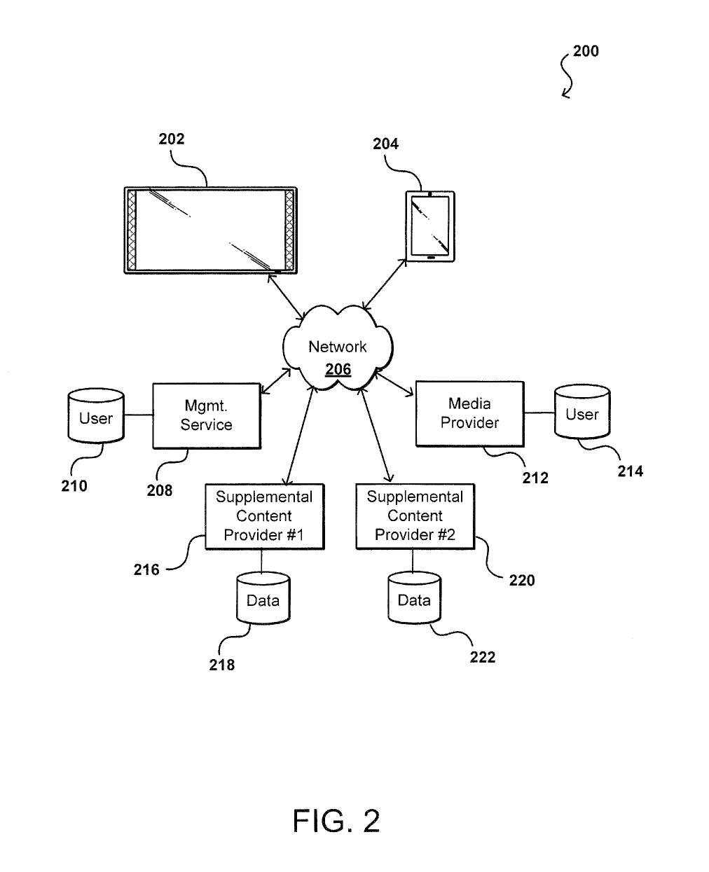

FIG. 2 illustrates an example system environment 200 in which aspects of the various embodiments can be implemented. In this example, a user can have one or more client devices 202, 204 of similar or different types, with similar or different capabilities. Each client device can make requests over at least one network 206, such as the Internet or a cellular network, to receive content to be rendered, played, or otherwise presented via at least one of the client devices. In this example a user is able to access media content, such as movies, videos, music, electronic books, and the like, from at least one media provider system or service 212 that stores media files in at least one data store 214. The data store can be distributed, associated with multiple providers, located in multiple geographic locations, etc. Other media provider sources can be included as well, as may comprise broadcasters and the like. In this example, at least some of the media obtained from the media provider system 212 can be managed by a management service 208 or other such entity. The management service can be associated with, or separate from, one or more media provider systems. A user might have an account with a management service, which can store user data such as preferences and account data in at least one data store 210. When a user submits a request for media content, the request can be received by the management service 208, which can verify or authenticate the user and/or request and ensure that the user has access rights to the content. Various other checks or verifications can be utilized as well. Once the user request is approved, the management service 208 can cause requested media from the media provider system 212 to be available to the user on at least one designated client device.

Using the example of FIG. 1, a user could request to stream a movie to the user's smart television 202. A connection and/or data stream can be established between the media provider system 212 and the television 202 to enable the content to be transferred to, and displayed on, the television. In some embodiments, the media content might include one or more tags, metadata, and/or other such information that can indicate to a client device and/or the management system that supplemental content is available for the media being presented. In other embodiments, as discussed elsewhere herein, software executing on the smart television (or on another computing device operable to obtain information about the media) can monitor the playback of the media file to attempt to determine whether supplemental information is available for the media content.

As discussed, supplemental content can include various types of information and data available from various sources, either related or from third parties. For example, a first supplemental content provider system 216 might offer data 218 about various media files, as may include trivia or facts about the content of the media file, people and locations associated with the content, related content, and the like. A second content provider system 220 might store data 222 about related items, such as items that are offered for consumption (e.g., rent, purchase, lease, or download) through an electronic marketplace. These can include, for example, consumer goods, video files, audio files, e-books, and the like. There can be one or more provider systems for each type of supplemental content, and a provider system might offer multiple types of supplemental content.

In this example, software executing on the smart television 202 might notice a tag in the media file during playback, during streaming, or at another appropriate time. Similarly, software executing on the television might monitor audio, image, and/or video information from the presentation to attempt to determine information about the content in the media file. For example, an audio analysis engine might monitor an audio feed for patterns that might be indicative of music, a person's voice, a unique pattern, and the like. Similarly, an image analysis engine might monitor the video feed for patterns that might be indicative of various persons, places, or things. Any such patterns can be analyzed on the device, transferred for analysis by the management servicer or another such entity, or both.

Analysis of audio, video, or other such information can result in various portions of the content being identified. For example, an audio or video analysis algorithm might be able to identify the particular movie, actors or places in the movie, music playing in the background, and other such information. Similarly, there might be tags or metadata with the media content that provide such identifying information. Based at least in part upon this information, an entity such as a management service 208, or other such entity, can determine supplemental content that is related to the identified information. For example, if the movie can be identified then related movies, books, soundtracks, and other information might be identified. Similarly, information about identified actors or locations might be located, as well as other media including those actors or locations. Similarly, downloadable versions of music in the media content might be located.

In some embodiments, any located supplemental content might be presented to the user, either through an interface on the television 202 or by pushing information to another device 204 that the user can use while viewing the media content on the television. In other embodiments, the supplemental content will be analyzed to attempt to determine how relevant, or likely of interest, that content is to the user. For example, a content management service 208 might utilize information about user preferences, purchase history, viewing history, and the like to assign a relevance score to at least a portion of the items of supplemental content. Based at least in part upon those scores, a portion of the supplemental content can be selected for presentation to the user. This can include any supplemental content with at least a minimum relevance score, only a certain number of highly relevant items over a period of time, or another such selection of the supplemental content.

Referring back to the example of FIG. 1, the management service 208 could potentially send a notification 106 to be displayed on the television, or current viewing device. A user viewing the notification can decide whether or not to act on the notification. In at least some embodiments, a user can select or otherwise provide input indicating that the user is interested in the supplemental content indicated by the notification. As discussed, in some embodiments the supplemental content can be displayed on the same computing or display device. In the example of FIG. 1, a user indicating interest in supplemental content associated with a notification 106 can have that content pushed, or otherwise transferred, to an associated computing device, in this example the user's tablet computer 110. In this way, the user can continue to view the content on the television if desired, but can access the supplemental content on the tablet computer 110. Such an interactive experience can provide additional information for a media file at the time when that additional information is most relevant. While conventional approaches might provide pre-processing of the media to include tags, or provide supplemental content only alongside a controlled live feed, approaches presented herein can enable real-time determinations of supplemental content based upon analyzing the media content itself. Further, embodiments enable a user to select where to send the supplemental content, and how to manage the supplemental content separate from the media content.

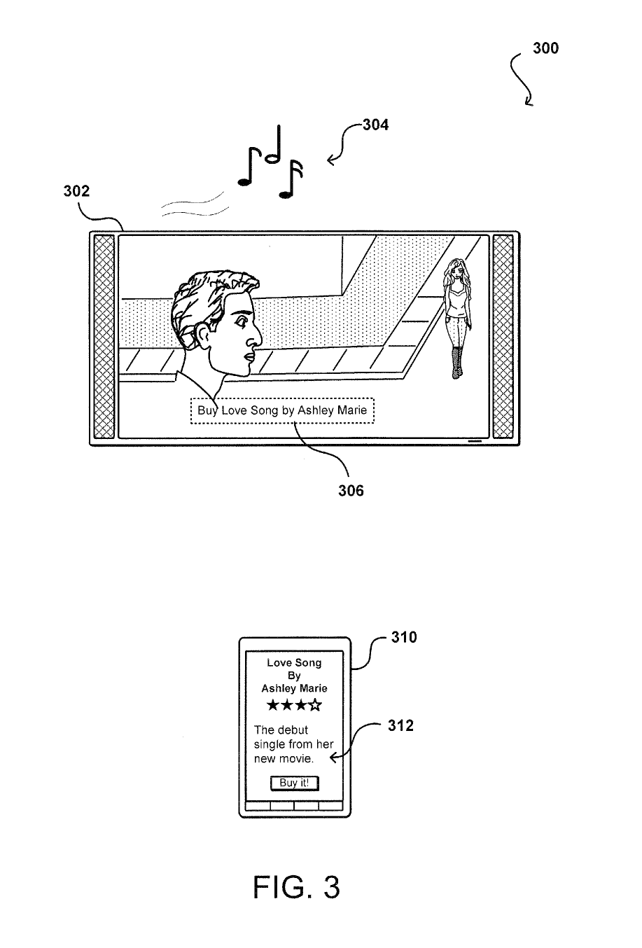

FIG. 3 illustrates another example approach 300 for notifying a user of supplemental content, and providing that supplemental content to the user. In this example, music 304 is playing in the background of a scene of a program being watched by a user. The music can be detected by software executing on the device 302 used to display the content, by a device (not shown) transferring the content, by a device 310 capable of capturing audio from the display device, or another such component. Upon recognizing a music pattern, an algorithm can analyze a portion of the music (either in real-time, upon a period of captured data, or by analyzing an amount of buffered data, for example), and attempt to locate a match for the music. Various audio matching algorithms are known in the art, such as that utilized by the Shazam® application offered by Shazam Entertainment Ltd. Such algorithms can analyze various patterns or feature in an audio snippet, and compare those patterns or features against a library of audio to attempt to identify the audio file. In response to locating a match, a determination can be made as to the available supplemental content for that match. For example, if the artist and title can be determined, a determination can be made as to whether a version of that song is available for purchase, what information is available about the artist or song, what other songs fans of that song like, etc. Based at least in part upon the types of information and/or supplemental content available, a determination can be made as to which, if any, of these types might be of interest to the user. For example, if the user has a history of purchasing hip hop music but not country music, and the song is identified to be performed by a country artist, then no information about that song might be supplied to the user. If, on the other hand, the user frequently purchases country music, a notification might be generated that enables the user to easily purchase a copy of that song. If the user has history, preference, or other information that indicates the user might have an interest in the song, or information about the song, a determination can be made as to how relevant the information might be to the user to determine whether to notify the user of the availability of the supplemental content. Various relatedness algorithms are known, such as for recommending related products or articles to a user based on past purchases, viewing history, and the like, and similar algorithms can be used to determine the relatedness of various types of information in accordance with the various embodiments.

In the example of FIG. 3 the song playing in the background has been identified, and it has been determined that the song is likely highly relevant to the user's interests. In this example, a notification 306 is displayed over the media content indicating the name and artist. In this example, the notification is a translucent notification that fades in, waits for a period of time, and then fades out. The user is still able to view the content through the notification. In this example where the song is indicated to be highly relevant to the user, the notification also enables the user to directly purchase the song. In addition to the notification, various other options can be provided as well. For example, the user might be able to perform an action with respect to the notification, such as to press a button on a remote control of the television or speak a command such as “buy song” that can be detected by at least one of the computing devices 302, 310, in order to purchase the song, which might then be added to an account or playlist of the user. A user also might be able to select an option or provide an input to obtain more information about the song. In this example, the user might select an option on a remote to have information for the song pushed to the portable device 310, might select an option on the portable device to view content for the notification, or in some embodiments the information 312 might be pushed to the portable device 310 as long as a supplemental content viewing application is active on the device. Various other approaches can be utilized as well within the scope of the various embodiments.

In this example, information 312 about the song is pushed to the tablet computer 310. The user can view information about the song on the device, while the media content is playing on the television (or other such device). In some embodiments, the user can have the option (through the television, the portable device, or otherwise) to pause the playback of the media while the user views information about the song. The user can have the option of obtaining the song through the tablet 310 as well as through the notification 306 on the television. In some embodiments, a user might receive an option to play a music video for the song, which the user can select to play through the tablet 310 or the television 302. In other embodiments, the user can bookmark the supplemental content for viewing after the media playback completes.

As mentioned, it should be understood that two or more devices of any appropriate type can be used as primary and/or secondary viewing devices, used to view media content and/or supplemental content. The user can also switch an operational mode of the devices such that a second device displays the media content and a first device, that was previously displaying the media content, now displays the supplemental content. Further, a single device can be used to enable the user to access both the primary and supplemental content.

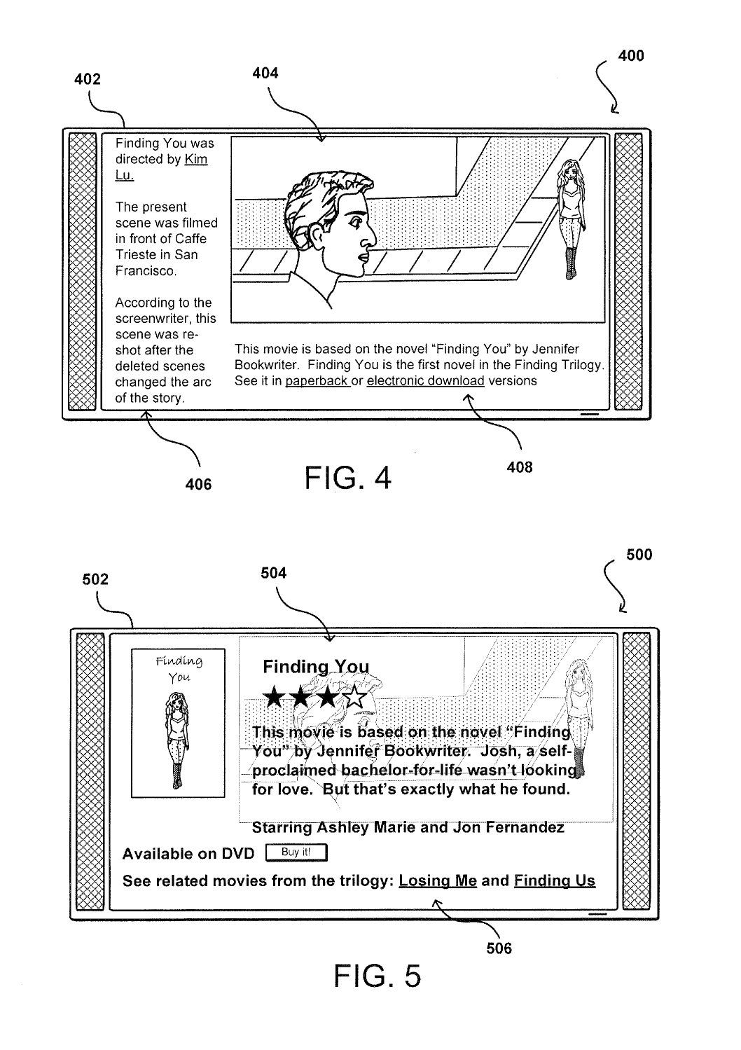

For example, FIG. 4 illustrates an example situation 400 wherein a user is utilizing an electronic device 402 to view media content, such as a streaming video. In this example, the user can select to have the video content 404 play in a portion of the display screen of the device. By displaying the video in only a portion of the screen, related supplemental content can be presented in other portions of the display screen, where the supplemental content can come from multiple sources. For example, trivia or factual content 406 about the video being played can be presented in a first section of the display. This can include information related to the video that is playing, whether in general, specific to the current location in the video playback, or both. Suggested item content 408 also can be displayed as relates to the video content. In this example the movie is based on a book and information about versions of the book that are available for purchase is displayed. The information can enable the user to purchase the book content directly, or can direct the user to a Web page or other location where the user can view information about the book and potentially obtain a copy of the book. In some embodiments the page content can open in a new window, while in other embodiments the content can be displayed in the same or a different portion or section of the display. In some embodiments, the media playback can pause automatically while the user is viewing additional pages of supplemental content, or the user can have the option of manually starting and stopping the video. In some embodiments, the video will resume playback when the additional page content is closed or exited, etc.

In some embodiments, the video playback section 404 can resize automatically when there is supplemental content to be displayed. For example, the video might utilize the full display area when there is no supplemental content to be displayed, and might shrink to a fixed size or a size that is proportional to the amount of supplemental content, down to a minimum section size. The various sizes, amount and type of supplemental content displayed, and other such aspects, can be configurable by the user in at least some embodiments. Further, the user can have the option of overriding or adjusting content that is displayed, such as by deactivating a playback of supplemental content during specific instances of content or types of content. For example, the user might select to always display supplemental content while watching viral videos or streaming television content, but might not want to have supplemental content displayed when watching movie content from a particular source. Similarly, the user might be able to adjust the way in which supplemental content is displayed for certain types of content. The user might enable the viral video window size to shrink to display supplemental content, but might not allow the window size to shrink during playback of a movie, allowing only minimally intrusive notifications of the existence of supplemental content.

A user might also be able to toggle supplemental content on and off during playback. For example, the user might have supplemental content turned off most of the time, and only turn on supplemental content when the user wants to obtain information about something in the playback. For example, if an actor walks on the screen that the user wants to identify, a character is wearing an item of interest to the user, a song of interest is playing in the background, etc., a user might activate supplemental content hoping to receive information about that topic of interest. Once obtaining the information, or after a period of time, the user can manually turn off supplemental content display, or the display can be set to automatically deactivate after a period of time.

In some embodiments a device might be configured to display video and supplemental content in at least partially overlapping regions, such that the user can continue to view video content while also viewing supplemental content. Such an approach might be particularly useful for devices such as smart phones and tablet computers that might have relatively small display screens. Similarly, such an approach might be beneficial for sporting events or other types of content where the user might not want to pause the video stream but does not want to miss any important events in the video. The user can also have the ability to switch which content is displayed in the translucent window.

FIG. 5 illustrates an example interface display 500 that can be presented in accordance with various embodiments. In this example, supplemental content 506 can be displayed that is related to video content 504 being presented on the device. The supplemental content can be displayed in response to a user selection, a determined presence of highly relevant content, or another such action or occurrence as discussed or suggested elsewhere herein. In this example, the user is able to view and interact with the supplemental content using most or all of the area of the screen. The user is also able to continue to have the video content 504 displayed using at least a portion of the display screen of the device 502. In this example, the video presentation becomes translucent, or at least partially transparent, whereby the user can view supplemental content 506 “underneath” the video presentation. Such an approach enables the device to utilize real estate of the display element to present the supplemental content, while enabling the video content to be concurrently displayed. The user can have the option of having the video presentation stop being translucent, go back to a full screen display, or otherwise become a primary display element at any time. In some embodiments, the video display can remain fully opaque and occupying a majority of the display screen, and the display of supplemental content can be translucent over at least a portion of the video content, such that the user can view the supplemental content without changing the display of video content. The user can also have the ability to change a transparency level of either the supplemental content or the video content in at least some embodiments.

In at least some embodiments, information can flow in both directions between an interface rendering the media content and an interface rendering the supplemental content, whether those interfaces are on the same device or a different device. For example, the media interface can detect the selection of a notification by a user, and send information about that selection to an application providing the supplemental content interface, which can cause related supplemental content to be displayed. Further, a user might select content or otherwise provide input through the supplemental content interface, which can cause information to be provided to the media interface. For example, a user purchasing a song using a tablet computer might have a notification displayed on the TV when the purchase is completed and the song is available. A user also might be able to select a link for a related movie in a supplemental content interface, and have that movie begin playing in the media interface. Various other communications can occur between the two interfaces in accordance with the various embodiments. Further, there can be additional windows or interfaces as well, such as where there are media and supplemental content interfaces on each of a user's television, tablet, and smart phone, or other such devices, which can all work together to provide a unified experience.

In some embodiments a set of APIs can be exposed that can enable the interfaces to communicate with each other, as well as with a content management service or other such entity. As discussed, in some situations a content provider will serve the information to be displayed on the client device, such that the content provider can determine the instance of media being displayed, a location in the media, available metadata, and other such information. In such an instance, a “listener” component that is listening for possible information to match can receive information about the media through an API call, or other such communication mechanism. The listener can perform a reverse metadata lookup or other such operation, and provide the information to the user as appropriate. If the media corresponds to a live broadcast or is provided from another source, a similar call can be made where the listener can attempt to perform a reverse lookup using information such as the location and time of day, and can potentially contact a listing service through an appropriate API to attempt to determine an identity of the media.

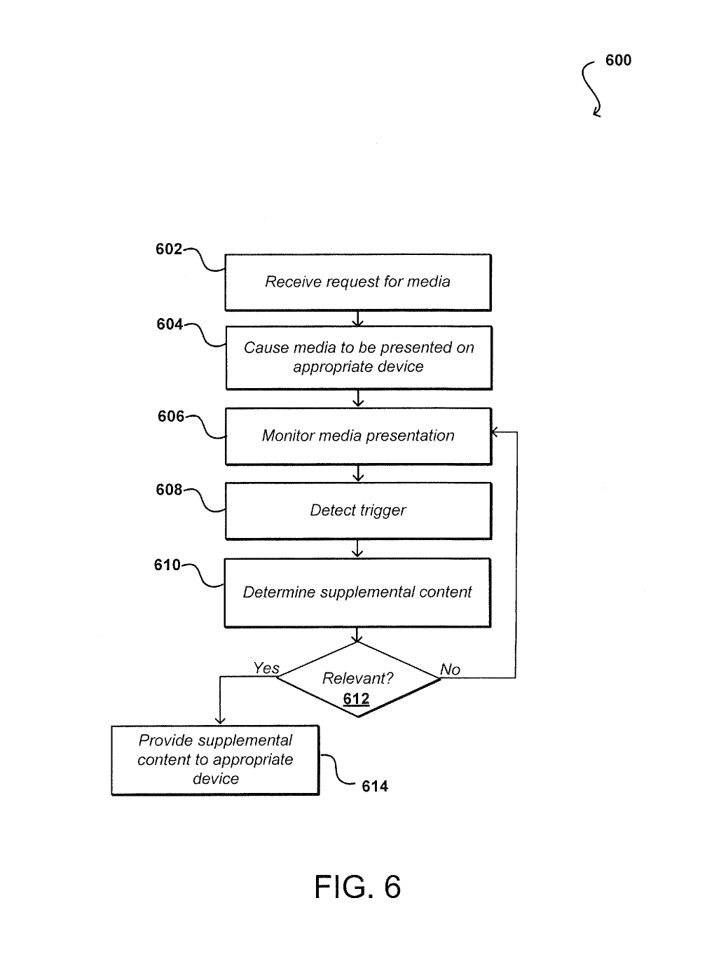

FIG. 6 illustrates an example process 600 for providing supplemental content that can be utilized in accordance with various embodiments. It should be understood that there can be additional, fewer, or alternative steps performed in similar or alternative orders, or in parallel, within the scope of the various embodiments unless otherwise stated. In this example, a request for media content is received 602 from an electronic device. The request can be received to an entity such as a content management service, as discussed elsewhere herein, that is operable to validate the request and determine whether the user and/or device has rights to view or access the media content. If the device is determined to be able to access the content, the media content can be caused 604 to be presented on the device. The content can be accessible by streaming the content to the device, enabling the device to download the content, allowing the device to receive a broadcast of the content, and the like. In some embodiments, the media content might be accessed from another source, but a request can be sent to a management service or other such entity that is able to provide supplemental content for that media.

During presentation of the media, or at another such appropriate time, the media presentation can be monitored 606 to attempt to determine the presence or occurrence of certain types of information. As discussed, the content can be monitored in a number of different ways, such as by monitoring a stream of data provided by a server for metadata, analyzing information for image or audio data sent by the device on which the media content is being presented, receiving information from software executing on the displaying device and monitoring the presentation for certain types of information, and the like. During the monitoring, a trigger can be detected 608 that indicates the potential presence of a certain type of information. This can include, for example, a new face entering a scene, a new clothing item appearing, a new song being played, and the like. A trigger also can be generated in response to the detection of a tag, metadata, or other such information associated with the media content. In response to the trigger, which can include information about the type of content, an attempt can be made to locate and/or determine 610 the availability of related supplemental content. As discussed herein, related supplemental content can include various types and forms of information or content that has some relationship to at least one aspect of the media content. For located supplemental content that is related to the media content, a determination can be made 612 as to whether that supplemental content is relevant to the user. As discussed, this can include analyzing information such as user preferences, purchasing history, search history, and the like, and determining how likely it is that the user will be interested in the supplemental content. This can include, in at least some embodiments, calculating a relevance score for each instance of supplemental content using the user information, then selecting up to a maximum number of instances that meet or exceed a minimum relevance threshold. Various other such approaches can be used as well. If none of the instances meet these or other such selection criteria, no supplemental content may be displayed and the monitoring process can continue until the presentation completes or another such action occurs. If supplemental content is located that at least meets these or other such criteria, that supplemental content can be provided 614 to the appropriate device for presentation to the user. As discussed, in some embodiments the user might receive supplemental content on a different device than is used to receive the media content. Further, providing the content might include transmitting the actual supplemental content or providing an address or link where the device can obtain the supplemental content. Various other approaches can be used as well within the scope of the various embodiments.

As mentioned, a user can interact with an electronic device in a number of different ways in order to control aspects of a presentation of media and/or supplemental content. For example, a user can utilize a remote control for a television to provide input, or can select an option on a tablet or other such computing device. Further, a user can provide voice input that can be detected by a microphone of such a device and analyzed using a speech recognition algorithm. In some embodiments, a voice recognition algorithm can be used such that commands are only accepted from an authorized user, or a primary user from among a group of people nearby.

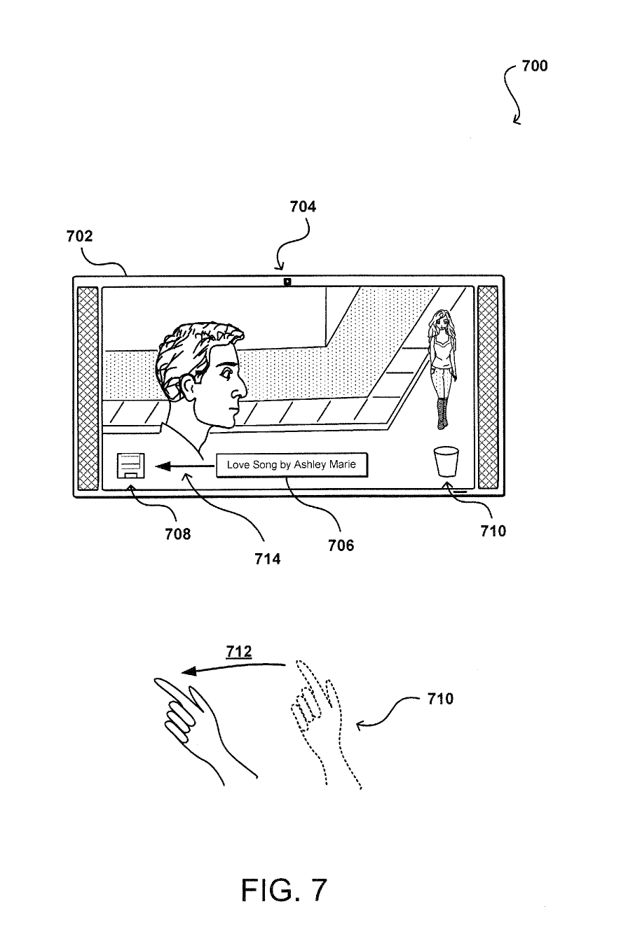

Similarly, gesture or motion input can be utilized that enables a user to provide input to a device by moving a finger, hand, held object, or other such feature with respect to the device. For example, a user can move a hand up to increase the volume, and down to decrease the volume. Various other types of motion or gesture input can be utilized as well. The motion can be detected by using at least one sensor, such as a camera 704 in an electronic device 702, as illustrated in the example configuration 700 of FIG. 7. In this example, the device 702 can analyze captured image data using an appropriate image recognition algorithm, which can attempt to recognize features, faces, contours, and the like. Upon recognizing a specific feature of the user, such as a hand or fingertip, the device can monitor the relative position of that feature to the device over time, and can analyze the path of motion. If the path of motion of the feature matches an input motion, the device can provide the input to the appropriate application, component, etc.

Such an approach enables various types of functionality and input to be provided to the user. For example, in FIG. 7 a notification 706 is displayed that provides to a viewer information about a song playing in the background. The user might be interested in the song, but not interested in stopping or pausing the movie to view the information. In this example, a pair of icons is also displayed on the screen with the notification. A first icon 708 indicates to the user that the user can save information for the notification, which the user can then view at a later time. A second icon 710 enables the user to delete the notification, such that the notification does not remain on the screen for a period of time, is not shown upon a subsequent viewing of this or another media file, etc. When a notification 706 is displayed on the screen, the user can use a feature such as the user's hand 710 or fingertip to make a motion that pushes or drags the notification towards the appropriate icon to save or delete the notification. In this example, the motion 712 guides the notification along a path 714 towards the save icon 708, such that the information for that song is saved for a later time. In some embodiments, information for that icon can be sent to the user via email, text message, instant message, or another such approach. In other embodiments, the information might be stored in such a way that the user can later access that information through an account or profile of that user. Various other options exist as well, such as to add the song to a wishlist or playlist, cause the song to be played, etc. Various other uses of gestures or motions can be used as well, as may include various inputs discussed and suggested herein. Other inputs can include, for example, tilting the device, moving the user's head in a certain direction, providing audio commands, etc. Further, a motion or gesture detected by one device can be used to provide input to a second device, such as where gesture input detected by a tablet can cause a television to stream particular content.

In some embodiments, at least some of the notifications and/or supplemental content can relate to advertising, either to related products and services offered by a content provider or from a third party. In at least some embodiments, a user might receive a reduced subscription or access price for receiving advertisements. In some embodiments, a user might be able to gain points, credits, or other discounts towards the obtaining of content from a service provider upon purchasing advertised items, viewing a number of advertisements, and the like. A user can view the number of credits obtain in a month or other such period, and can request to see additional (or fewer) advertisements based upon the obtained credits or other such information. A user can also use such a management interface to control aspects such as the type of advertising or supplemental content that is displayed, a rate or amount of advertising, etc.

As discussed, different types of media can have information determined in different ways. Media served by a content provider can be relatively straightforward for the content provider to identify. In other cases, however, the identification process can be more complex. As discussed, identifying broadcast content can involve performing a look-up against a listing service or other such source to identify programming available in a particular location at a particular time. For audio, video, or other such media that may or may not be able to be so identified, a listener or other such module or component can analyze the audio and/or video portions of a media file in near-real time to attempt to identify the content by recognizing features, patterns, or other aspects of the media. As mentioned, this can include identifying songs in the background of a video, people whose faces are shown in a video, objects displayed in an image, and other such objects. The analyzing can involve various pre-processing steps, such as to remove background noise, isolate foreground image objects, and the like. Audio recognition can be used not only to identify songs, but also to identify the video containing the audio portions, determine an identity of a speaker using voice recognition, etc. Further, image analysis can be used to identify actors in a scene or other such information, which can also help to identify the media and other related objects.

The information available for an instance of media content can be provided by, or obtained from, any of a number of different sources. For example, a publisher or media company might provide certain data with the digital content. Similarly, an employee or service of a content provider or third party provider might provide information for specific instances of content based on information such as an identity of the content. In at least some embodiments, users might also be able to provide information for various types of content. For example, a user watching a movie might identify an item of clothing, an actor, a location, or other such information, and might provide that information using an application or interface configured for such purposes. The user information can be available instantly, or only after approval through a determined type of review process. In some embodiments, other users can vote on, or rate, the user information, and the information will only be available after a certain amount of confirmation from other users. Various other approaches can be used as well, as may include those known or used for approving content to be posted to a network site.

Information for other users can be used in selecting supplemental content to display to a user as well. For example, a user might be watching a television show. A recommendations engine might analyze user data to determine other shows that viewers of that show watched, and can recommend one or more of these other shows to the user. If a song is playing in the background of a video and a user buys that song, or has previously purchased a copy of that song, the recommendations engine might suggest other songs that fans of the song have purchased, listened to, rated, or otherwise interacted. A recommendation engine might recommend other songs by an artist, books upon which songs or movies were based, or other such objects or items.

Similarly, user specific data such as purchase and viewing history, search information, and preferences can be used to suggest, determine, or select supplemental content to display to a user. For example, a user might only purchase movies in widescreen or 3D formats, so a recommendations engine might use this information when determining the relevance of a piece of content. Similarly, if the user never watches horror movies but often watches love stories, the recommendations engine can use this information when selecting supplemental content to display to a user. Various types of information to use when recommending content to a user, and various algorithms used to determine content to recommend, can be used as is known or used for various purposes, such as recommending products in an electronic marketplace.

In some embodiments, a device or service might attempt to identify one or more viewers or consumers of the content at a current time and/or location in order to select supplemental content that is appropriate for those viewers or consumers. For example, if a device can recognize two users in a room, the device can select supplemental content that will likely be of interest to either user, or both. If the device cannot recognize at least one user but can recognize an age or gender of a viewer of media content, for example, the device can attempt to provide appropriate supplemental content, even where the profile for the primary user would otherwise allow additional content. For example, an adult user might be able to view mature content, such as shows or games containing violence, but might not want a child viewing the related supplemental content, even when the user is also viewing the content. In some embodiments, a user can configure privacy or viewing restrictions, among other such options. A device can attempt to identify a user through image recognition, voice recognition, biometrics, and the like. In some cases, a user might have to login to an account, provide a password, utilize a biometric sensor or microphone of a remote control, etc.

In some embodiments, the amount, type, and/or extent of supplemental information provided can depend upon factors such as a mode of operation, size or resolution of a display, location, time or day, or other such information. In some embodiments, media content will be played on a device such as a television when available, but a system or service can attempt to guide the user back to a device such as a tablet or smart phone to obtain supplemental content. Such an approach can leverage a device with certain capabilities, for example, but in at least some embodiments will attempt to disturb the media presentation as little as possible, such that a user wanting to obtain supplemental content can utilize the secondary device but a user interested in the media content can set the secondary device aside and not be disturbed. In at least some embodiments, a user can have the option of temporarily or permanently shutting off supplemental content, or at least shutting off the notifications of the availability of supplemental content through a television or other such device. Also as discussed, the amount of activity with content on a first device can affect the way in which content is displayed on a second device. For example, a user navigating through supplemental content on a second device can cause a media presentation on a first screen to pause for at least a period of time. Similarly, if a user is frequently maneuvering to different media content on a primary device, the secondary device might not suggest supplemental content until the user settles on an instance of content for at least a period of time. For example, if the user is channel surfing the user might not appreciate receiving one or more notifications for supplemental content each time the user passes by a channel, at least unless the user pauses for a period of time to obtain information about the channel or media, etc.

In some embodiments, a system or service might “push” certain information to the device pre-emptively, such as when a user downloads a media file for viewing. For example, metadata could be sent with the media file for use in generating notifications at appropriate times. Then, when a user is later viewing that content, the user can receive notifications without network or related delays, and can receive notifications even if the user is in a location where a wireless (or wired) network is not available. In some embodiments a user might not be able to access a full range of supplemental content when not connected to a network, but may be able to receive a subset that was cached for potential display with the media, or can cause information to be stored that the user can later use to obtain the supplemental content when a connection is available. Due at least in part to the limited storage capacity and memory of a portable computing device, for example, a subset of available supplemental content can be pushed to the device. In at least some embodiments, the supplemental content can be ranked or scored using a relevance engine or other such component or algorithm, and content with at least a minimum relevance score or other such selection criterion can be cached on the device for potential subsequent retrieval. This cache of data can be periodically updated in response to additional content being accessed or obtained, and the cache can be a FIFO buffer such that older content is pushed from the cache. Various other storage and selection approaches can be used as well within the scope of the various embodiments.

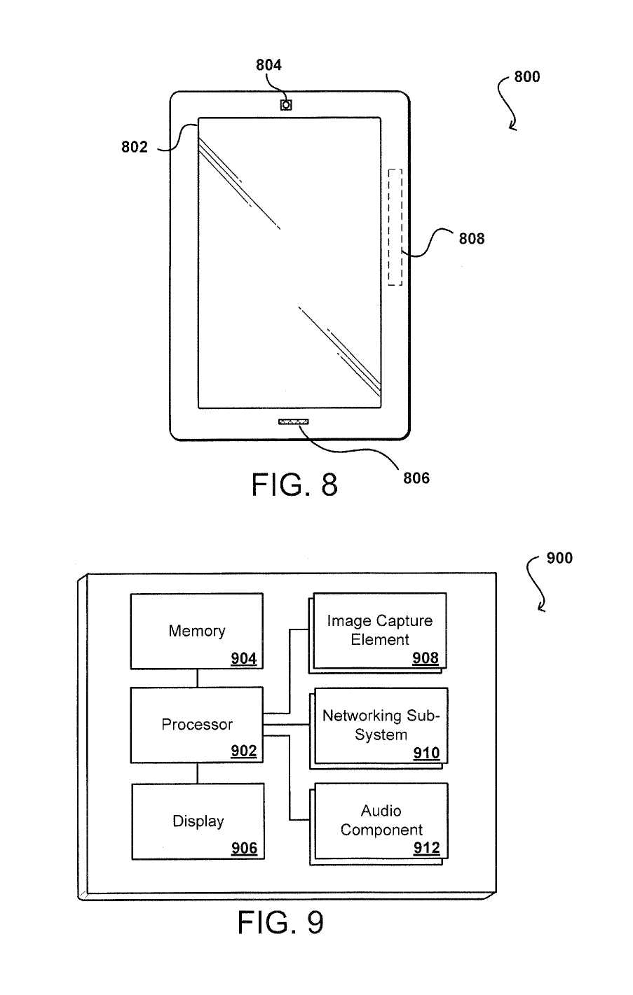

FIG. 8 illustrates an example electronic user device 800 that can be used in accordance with various embodiments. Although a portable computing device (e.g., an electronic book reader or tablet computer) is shown, it should be understood that any electronic device capable of receiving, determining, and/or processing input can be used in accordance with various embodiments discussed herein, where the devices can include, for example, desktop computers, notebook computers, personal data assistants, smart phones, video gaming consoles, television set top boxes, and portable media players. In this example, the computing device 800 has a display screen 802 on the front side, which under normal operation will display information to a user facing the display screen (e.g., on the same side of the computing device as the display screen). The computing device in this example includes at least one camera 804 or other imaging element for capturing still or video image information over at least a field of view of the at least one camera. In some embodiments, the computing device might only contain one imaging element, and in other embodiments the computing device might contain several imaging elements. Each image capture element may be, for example, a camera, a charge-coupled device (CCD), a motion detection sensor, or an infrared sensor, among many other possibilities. If there are multiple image capture elements on the computing device, the image capture elements may be of different types. In some embodiments, at least one imaging element can include at least one wide-angle optical element, such as a fish eye lens, that enables the camera to capture images over a wide range of angles, such as 180 degrees or more. Further, each image capture element can comprise a digital still camera, configured to capture subsequent frames in rapid succession, or a video camera able to capture streaming video.

The example computing device 800 also includes at least one microphone 806 or other audio capture device capable of capturing audio data, such as words or commands spoken by a user of the device. In this example, a microphone 806 is placed on the same side of the device as the display screen 802, such that the microphone will typically be better able to capture words spoken by a user of the device. In at least some embodiments, a microphone can be a directional microphone that captures sound information from substantially directly in front of the microphone, and picks up only a limited amount of sound from other directions. It should be understood that a microphone might be located on any appropriate surface of any region, face, or edge of the device in different embodiments, and that multiple microphones can be used for audio recording and filtering purposes, etc. The example computing device 1000 also includes at least one networking element 808, such as cellular modem or wireless networking adapter, enabling the device to connect to at least one data network.

FIG. 9 illustrates a logical arrangement of a set of general components of an example computing device 900 such as the device 800 described with respect to FIG. 8. In this example, the device includes a processor 902 for executing instructions that can be stored in a memory device or element 904. As would be apparent to one of ordinary skill in the art, the device can include many types of memory, data storage, or non-transitory computer-readable storage media, such as a first data storage for program instructions for execution by the processor 902, a separate storage for images or data, a removable memory for sharing information with other devices, etc. The device typically will include some type of display element 906, such as a touch screen or liquid crystal display (LCD), although devices such as portable media players might convey information via other means, such as through audio speakers. As discussed, the device in many embodiments will include at least one image capture element 908 such as a camera or infrared sensor that is able to image projected images or other objects in the vicinity of the device. Methods for capturing images or video using a camera element with a computing device are well known in the art and will not be discussed herein in detail. It should be understood that image capture can be performed using a single image, multiple images, periodic imaging, continuous image capturing, image streaming, etc. Further, a device can include the ability to start and/or stop image capture, such as when receiving a command from a user, application, or other device. The example device similarly includes at least one audio component 912, such as a mono or stereo microphone or microphone array, operable to capture audio information from at least one primary direction. A microphone can be a uni-or omni-directional microphone as known for such devices.

In some embodiments, the computing device 900 of FIG. 9 can include one or more communication elements or networking sub-systems 910, such as a Wi-Fi, Bluetooth, RF, wired, or wireless communication system. The device in many embodiments can communicate with a network, such as the Internet, and may be able to communicate with other such devices. In some embodiments the device can include at least one additional input device able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device.

The device 900 also can include at least one orientation or motion sensor (not shown). Such a sensor can include an accelerometer or gyroscope operable to detect an orientation and/or change in orientation, or an electronic or digital compass, which can indicate a direction in which the device is determined to be facing. The mechanism(s) also (or alternatively) can include or comprise a global positioning system (GPS) or similar positioning element operable to determine relative coordinates for a position of the computing device, as well as information about relatively large movements of the device. The device can include other elements as well, such as may enable location determinations through triangulation or another such approach. These mechanisms can communicate with the processor 902, whereby the device can perform any of a number of actions described or suggested herein.

As an example, a computing device such as that described with respect to FIG. 8 can capture and/or track various information for a user over time. This information can include any appropriate information, such as location, actions (e.g., sending a message or creating a document), user behavior (e.g., how often a user performs a task, the amount of time a user spends on a task, the ways in which a user navigates through an interface, etc.), user preferences (e.g., how a user likes to receive information), open applications, submitted requests, received calls, and the like. As discussed above, the information can be stored in such a way that the information is linked or otherwise associated whereby a user can access the information using any appropriate dimension or group of dimensions.

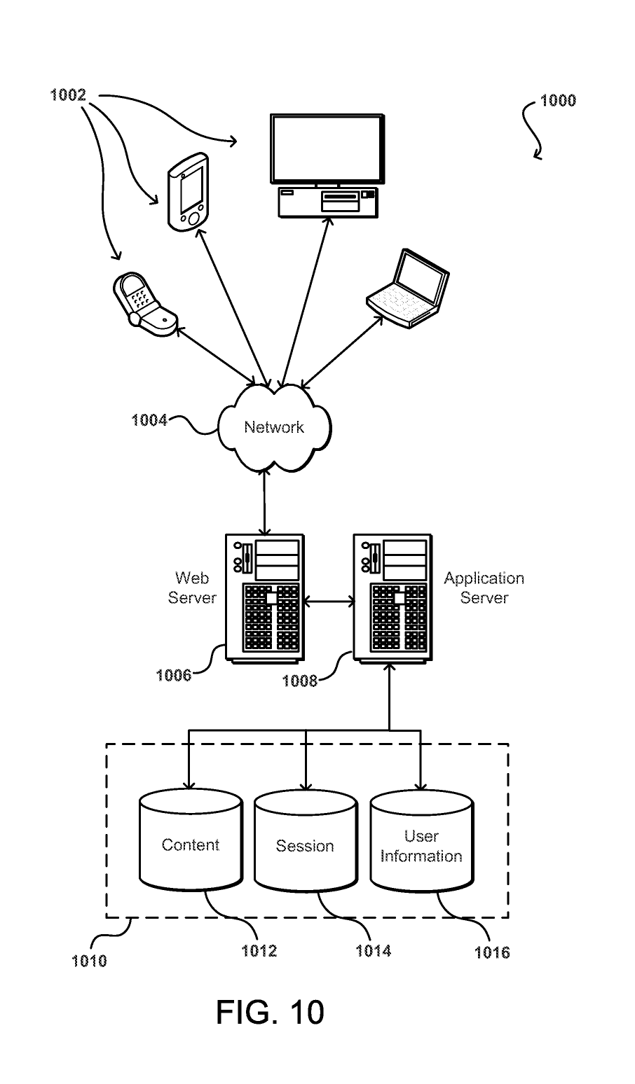

As discussed, different approaches can be implemented in various environments in accordance with the described embodiments. For example, FIG. 10 illustrates an example of an environment 1000 for implementing aspects in accordance with various embodiments. As will be appreciated, although a Web-based environment is used for purposes of explanation, different environments may be used, as appropriate, to implement various embodiments. The system includes an electronic client device 1002, which can include any appropriate device operable to send and receive requests, messages or information over an appropriate network 1004 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 1006 for receiving requests and serving content in response thereto, although for other networks, an alternative device serving a similar purpose could be used, as would be apparent to one of ordinary skill in the art.

The illustrative environment includes at least one application server 1008 and a data store 1010. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server 1008 can include any appropriate hardware and software for integrating with the data store 1010 as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server 1006 in the form of HTML, XML or another appropriate structured language in this example. The handling of all requests and responses, as well as the delivery of content between the client device 1002 and the application server 1008, can be handled by the Web server 1006. It should be understood that the Web and application servers are not required and are merely example components, as structured code discussed herein can be executed on any appropriate device or host machine as discussed elsewhere herein.

The data store 1010 can include several separate data tables, databases or other data storage mechanisms and media for storing data relating to a particular aspect. For example, the data store illustrated includes mechanisms for storing content (e.g., production data) 1012 and user information 1016, which can be used to serve content for the production side. The data store is also shown to include a mechanism for storing log or session data 1014. It should be understood that there can be many other aspects that may need to be stored in the data store, such as page image information and access rights information, which can be stored in any of the above listed mechanisms as appropriate or in additional mechanisms in the data store 1010. The data store 1010 is operable, through logic associated therewith, to receive instructions from the application server 1008 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 1002. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 10. Thus, the depiction of the system 1000 in FIG. 10 should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more

Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-implemented method, comprising:
identifying metadata associated with media content;
identifying, based at least on the metadata, supplemental content, wherein the supplemental content includes at least one of information identifying an audio segment, information identifying a geographic location, or information identifying a person;
causing display of the media content on a first electronic device; and
based at least in part on a user selection, causing display of the supplemental content.

2. The computer-implemented method of claim 1, further comprising causing display of the supplemental content on the first electronic device.

3. The computer-implemented method of claim 1, further comprising causing display of the supplemental content on a second electronic device.

4. The computer-implemented method of claim 1, further comprising causing a synchronized display of the supplemental content with display of the media content.

5. The computer-implemented method of claim 1, further comprising causing display of the supplemental content as a partially transparent overlay of the media content.

6. The computer-implemented method of claim 5, further comprising causing a change in transparency of the partially transparent overlay.

7. The computer-implemented method of claim 1, further comprising causing display of the media content to pause while causing display of the supplemental content.

8. The computer-implemented method of claim 1, further comprising analyzing the media content to identify the metadata associated with the media content.

9. The computer-implemented method of claim 1, further comprising:
causing display of the media content is a first interface of the first electronic device; and
causing display of the supplemental content in a second interface of the first electronic device.

10. The computer-implemented method of claim 1, further comprising causing display of a notification on the first electronic device, the notification being related to the supplemental content.

11. A computing system, comprising:
a memory;
at least one processor; and
computer-readable storage medium for storing instructions, the instructions when executed by the at least one processor enabling the computing system to:
identify metadata associated with media content;
identify, based at least on the metadata, supplemental content, wherein the supplemental content includes at least one of information identifying an audio segment, information identifying a geographic location, or information identifying a person;
cause display of the media content on a first electronic device; and
based at least in part on a user selection, cause display of the supplemental content.

12. The computing system of claim 11, wherein the instructions when executed further enable the computing system to cause display of the supplemental content on the first electronic device.

13. The computing system of claim 11, wherein the instructions when executed further enable the computing system to cause display of the supplemental content on a second electronic device.

14. The computing system of claim 11, wherein the instructions when executed further enable the computing system to cause a synchronized display of the supplemental content with display of the media content.

15. The computing system of claim 11, wherein the instructions when executed further enable the computing system to cause display of the supplemental content as a partially transparent overlay of the media content.

16. The computing system of claim 15, wherein the instructions when executed further enable the computing system to cause a change in transparency of the partially transparent overlay.

17. The computing system of claim 11, wherein the instructions when executed further enable the computing system to cause display of the media content to pause while causing display of the supplemental content.

18. The computing system of claim 11, wherein the instructions when executed further enable the computing system to analyze the media content to identify the metadata associated with the media content.

19. The computing system of claim 11, wherein the instructions when executed further enable the computing system to:
cause display of the media content is a first interface of the first electronic device; and
cause display of the supplemental content in a second interface of the first electronic device.

20. The computing system of claim 11, wherein the instructions when executed further enable the computing system to cause display of a notification on the first electronic device, the notification being related to the supplemental content.
